(19) United States
(12) Patent Application Publication
(10) Pub. No.: US 2018/0363178 A1
(43) Pub. Date: Dec. 20, 2018

(54) CARBON FIBER NON-WOVEN CLOTH, METHOD OF PRODUCING CARBON FIBER NON-WOVEN CLOTH, CARBON FIBER MULTI-LAYER CLOTH AND COMPOSITE MATERIAL

(71) Applicant: HITACHI CHEMICAL COMPANY, LTD., Tokyo (JP)

(72) Inventor: Tomoko KOIZUMI, Chiyoda-ku, Tokyo (JP)

(21) Appl. No.: 15/737,090

(22) PCT Filed: Mar. 8, 2016
(86) PCT No.: PCT/JP2016/057160

§ 371 Date: Dec. 15, 2017

(51) Int. Cl. D04H 1/4242; B32B 27/12

(52) U.S. Cl. CPC D04H 1/4242; B32B 2262/106; B32B 27/12

(57) ABSTRACT

A carbon fiber non-woven cloth that satisfies at least one of the following (1) to (3): (1) includes a carbon fiber that does not substantially include an organic material, (2) includes a carbon fiber that does not form a strand, or (3) includes a carbon fiber that is a retrieved product from a composite material including the carbon fiber and an organic substance.

### TECHNICAL FIELD

The invention relates to a carbon fiber non-woven cloth, a method of producing a carbon fiber non-woven cloth, a carbon fiber multi-layer cloth, and a composite material.

### BACKGROUND ART

Composite materials of an organic substance such as a resin and an inorganic material such as carbon are used in various fields. Carbon fiber reinforced plastic (CFRP), which includes a material (cloth material) in which carbon fibers are orthogonally crossed or a carbon fiber material (unidirectional (UD) material) in which carbon fibers are arranged in one direction, and a resin material, is known as such a composite material.

Recently, resin transfer molding (RTM) has been attracting attention as a method of producing CFRP. In this method, CFRP is produced by injecting a resin into a mold in which carbon fibers are placed such that the carbon fibers are impregnated with the resin, and curing the resin. Therefore, RTM is suitable for producing a three-dimensional object. In this regard, although a cloth material and a UD material exhibit excellent strength, these materials have restrictions in terms of molding an object by RTM. In view of this, use of a carbon fiber non-woven cloth, in which carbon fibers are positioned in a random manner, for the production of CFRP by RTM has been attempted (see, for example, Japanese Patent Application Laid-Open (JP-A) No. 2012-188779).

### SUMMARY OF THE INVENTION

### Problems to be Solved by the Invention

Since resin is injected into a mold and carbon fibers are impregnated with the resin in the process of RTM, it is important to allow the resin to penetrate the carbon fibers and achieve a tight fixation in order to improve the strength of the obtained CFRP.

In view of the above, the invention aims to provide a carbon fiber non-woven cloth that forms a composite material with excellent moldability and strength. The invention also aims to provide a method of producing a carbon fiber non-woven cloth, a carbon fiber multi-layer cloth, and a composite material.

### Means for Solving the Problems

The means for solving the problems include the following embodiments.

<1> A carbon fiber non-woven cloth that satisfies at least one of the following (1) to (3):

(1) includes a carbon fiber that does not substantially include an organic material,

(2) includes a carbon fiber that does not form a strand, or

(3) includes a carbon fiber that is a retrieved product from a composite material including the carbon fiber and an organic substance.

<2> The carbon fiber non-woven cloth according to <1>, wherein a length of the carbon fiber is from 20 mm to 150 mm.

<3> The carbon fiber non-woven cloth according to <1> or <2>, further comprising a resin fiber.

<4> A method of producing the carbon fiber non-woven cloth according to any one of <1>to <3>, the method comprising, in the following order:

a contact process of contacting a processing solution with a composite material, the composite material including a carbon fiber and an organic substance that decomposes in the processing solution;

a separation process of separating the processing solution, which includes a decomposition product of the organic substance, from the carbon fiber; and

a non-woven cloth producing process of producing a carbon fiber non-woven cloth using the carbon fiber that is obtained through the contact process and the separation process.

5. The method of producing a carbon fiber non-woven cloth according to claim 4, wherein the organic substance comprises a resin including an ester bond.

6. The method of producing a carbon fiber non-woven cloth according to claim 4 or claim 5, wherein the processing solution comprises an organic solvent and a decomposition catalyst.

7. A carbon fiber multi-layer cloth, comprising the carbon fiber non-woven cloth according to any one of claim 1 to claim 3 and a sheet in which carbon fibers are oriented in at least one direction.

8. A composite material, comprising the carbon fiber non-woven cloth according to any one of claim 1 to claim 3 or the carbon fiber multi-layer cloth according to claim 7, and a resin.

### Effect of the Invention

According to the invention, a carbon fiber non-woven cloth that forms a composite material with excellent moldability and strength is provided. Also, a method of producing a carbon fiber non-woven cloth, a carbon fiber multi-layer cloth, and a composite material are provided.

### Embodiments for Implementing the Invention

The embodiments for implementing the invention are explained below. However, the invention is not limited to the embodiments. The elements of the embodiments (including steps) are not essential, unless otherwise stated. The numbers and the ranges thereof do not limit the invention either.

In the specification, “process” refers not only to a process that is independent from other steps, but also to a step that cannot be clearly distinguished from other steps, as long as the aim of the process is achieved.

In the specification, the numerical range represented by from A to B includes A and B as a maximum value and a minimum value, respectively.

In the specification, the minimum and maximum values of one of the numerical ranges described in a gradual manner may be replaced by the minimum and maximum values of the other numerical range, or may he replaced by the corresponding values shown in the Examples.

In the specification, when there is more than one kind of substance corresponding to a component of a composition, the content of the component refers to a total content of the substances, unless otherwise stated.

In the specification, when a composition includes more than one kind of particles, the particle size of the particles refers to a particle size of a mixture of the particles in the component, unless otherwise stated.

In the specification, a “layer” may be formed over an entire region or may be formed over part of a region, upon observation of the region.

In the specification, “laminate” refers to stacking two or more layers, and the two or more layers may be fixed or detachable from each other.

<Carbon Fiber Non-Woven Cloth>

The carbon fiber non-woven cloth satisfies at least one of the following (1) to (3):

(1) includes a carbon fiber that does not substantially include an organic material,

(2) includes a carbon fiber that does not form a strand, or

(3) includes a carbon fiber that is a retrieved product from a composite material including the carbon fiber and an organic substance.

### First Aspect

A first aspect of the embodiment is a carbon fiber non-woven cloth that includes a carbon fiber that does not substantially include an organic substance.

The inventors have found that a composite material produced by using a carbon fiber non-woven cloth that includes a carbon fiber that does not substantially include an organic substance exhibits an excellent strength as compared with a carbon fiber non-woven cloth that includes a carbon fiber that includes an organic substance. The reason for this is not clear, but is presumed to be that a carbon fiber non-woven cloth that includes a carbon fiber that does not substantially include an organic substance has a favorable compatibility with a resin to be injected among the carbon fibers, thereby achieving a tight fixation.

In the specification, the “organic substance” refers to a surface treatment agent, such as a sizing agent that is applied to a surface of a strand or a filament that forms the strand for the purpose such as retaining a state of carbon fiber to form a strand and improving handleability, and a resin that is in contact with the carbon fiber in the composite material.

In the specification, the “carbon fiber non-woven cloth” refers to a non-woven cloth in which the proportion of the carbon fibers in the total mass of the carbon fiber non-woven cloth is 10% by mass or more.

In the specification, the carbon fiber “does not substantially include an organic substance” refers to that the proportion of the organic substance in the total mass of the carbon fiber and the organic substance is 0% by mass or 3% by mass or less.

The proportion of the organic substance in the total mass of the carbon fiber and the organic substance can be determined by the following method.

Carbon fibers are dried at 100° C. for 20 minutes and subjected to a thermal treatment in the air with a muffle furnace (for example, Yamato Scientific Co., Ltd., FP311) at 500° C. for 45 minutes. Then, the proportion of the resin is calculated from a decrease in the mass during the thermal treatment. Specifically, when the value calculated by a formula: (mass before thermal treatment−mass after thermal treatment)/mass before thermal treatment×100 (%) is 0% by mass or 3% by mass or less, it is determined that the carbon fiber does not substantially include an organic substance. The proportion of the organic substance in the total mass of the carbon fiber and the organic substance is preferably 2.5% by mass or less, more preferably 2% by mass or less.

The proportion of the “carbon fiber that does not substantially include an organic substance” in the carbon fiber non-woven cloth is not particularly limited, and may be selected depending on the purpose of the carbon the carbon fiber non-woven cloth. For example, the proportion may be 20% by mass or more, preferably 30% by mass or more, more preferably 35% by mass or more, in the total mass of carbon fibers included in the carbon fiber non-woven cloth.

The carbon fiber included in the carbon fiber non-woven cloth is not particularly limited and may be selected from the carbon fibers generally used for producing a composite material.

Examples of the carbon fiber that does not substantially include an organic substance includes a carbon fiber that is not applied with a surface treatment agent as described above, and a carbon fiber from which at least a part of a surface treatment agent has been removed. A carbon fiber used for the production of a composite material generally is in a state of a strand that is formed of multiple filaments.

Examples of the method of removing an organic substance from a carbon fiber include a method of subjecting a carbon fiber or a composite material to a thermal treatment at a temperature at which an organic substance is eliminated (see, for example, JP-A No. 2013-237716) and a method of contacting a processing solution capable of decomposing an organic substance with a carbon fiber or a composite material (see, for example, JP-A No. 2001-172426).

The treatment for removing an organic substance from a carbon fiber may be a treatment for retrieving a carbon fiber from a composite material that includes the carbon fiber and an organic substance.

From the viewpoint of reducing the damage to the carbon fiber and reducing the amount of the residual organic substance, a method of using a processing solution including an organic solvent and a decomposition catalyst is preferred. In terms of cost, a method of removing an organic substance such as a resin from a waste material generated in the production of a prepreg, CFRP and the like is preferred.

The length of the carbon fiber in the carbon fiber non-woven cloth is not particularly limited. From the viewpoint of processability of a non-woven cloth, the length of the carbon fiber is preferably 20 mm or more. From the viewpoint of the strength of a carbon fiber non-woven cloth, or the strength of a multi-layer cloth or a composite material produced by using the carbon fiber non-woven cloth, the length of the carbon fiber is preferably 150 mm or less. The length of the carbon fiber as mentioned herein refers to a number average value of 100 carbon fibers that are selected at random from the carbon fiber non-woven cloth.

The diameter of the carbon fiber in the carbon fiber non-woven cloth is not particularly limited. From the viewpoint of processability of a non-woven cloth, the diameter of the carbon fiber is preferably from 3 μm to 10 μm. The diameter of the carbon fiber as mentioned herein refers to a number average value of 100 carbon fibers (filaments) that are selected at random from the carbon fiber non-woven cloth. When the carbon fiber has an uneven diameter, the diameter at the smallest portion is determined as the diameter of the carbon fiber.

The thickness of the carbon fiber non-woven cloth is not particularly limited, and may be selected depending on the structure or the purpose of the composite material to be produced by using the carbon fiber non-woven cloth. For example, from the viewpoint of suppressing the unevenness in thickness, the thickness of the carbon fiber non-woven cloth is preferably from 5 mm to 100 mm. The carbon fiber non-woven cloth may be used alone or as a laminate or two or more. When the non-woven cloth is a laminate of two or more, the thickness thereof refers to the total thickness of the two or more.

### Second Aspect

A second aspect of the embodiment is a carbon fiber non-woven cloth that includes a carbon fiber that does not form a strand.

The inventors have found that a composite material produced by using a carbon fiber non-woven cloth that includes a carbon fiber that does not form a strand exhibits an excellent strength as compared with a carbon fiber non-woven cloth that does not include a carbon fiber that does not form a strand. The reason for this is not clear, but is presumed to be that a carbon fiber non-woven cloth that includes a carbon fiber that does not form a strand has a favorable compatibility with a resin, thereby achieving a tight fixation. In addition, since a carbon fiber that does not form a strand exits as an independent filament obtained by the opening of a strand, rather than in the form of a strand in which filaments are fixed to each other, entanglement of the carbon fibers is suppressed and a more uniform carbon fiber non-woven cloth can be produced.

In the specification, the carbon fiber “does not form a strand” refers to that the carbon fiber exists as an independent filament without forming a strand. The “carbon fiber that does not form a strand” refers to both a carbon fiber that does not form a strand at all and a carbon fiber that partly forms a strand.

Examples of the method of obtaining a carbon fiber that does not form a strand include a method of subjecting a carbon fiber or a composite material to a thermal treatment at a temperature at which an organic substance is eliminated (see, for example, JP-A No. 2013-237716) and a method of contacting a processing solution capable of decomposing an organic substance with a carbon fiber or a composite material (see, for example, JP-A No. 2001-172426).

From the viewpoint of reducing the damage to the carbon fiber and reducing the amount of the residual organic substance, a method of using a processing solution including an organic solvent and a decomposition catalyst is preferred. In terms of cost, a method of removing an organic substance such as a resin from a waste material generated in the production of a prepreg, CFRP and the like is preferred.

The proportion of the “carbon fiber that does not form a strand” in the carbon fiber non-woven cloth is not particularly limited, and may be selected depending on the purpose or the like of the carbon fiber non-woven cloth. For example, the proportion of the “carbon fiber that does not form a strand) may be 10% by mass or more of the total mass of the carbon fiber in the carbon fiber non-woven cloth, preferably 30% by mass or more, more preferably 50% by mass or more.

In this aspect, the length of the carbon fiber, the diameter of the carbon fiber, and the thickness of the carbon fiber non-woven cloth are not particularly limited, and preferred ranges thereof are the same as the first aspect.

### Third Aspect

A third aspect of the embodiment is a carbon fiber non-woven cloth that includes a carbon fiber that is a retrieved product from a composite material including a carbon fiber and an organic substance.

The inventors have found that a composite material produced by using a carbon fiber non-woven cloth that includes a carbon fiber that is a retrieved product from a composite material exhibits an excellent strength as compared with a carbon fiber non-woven cloth that does not include a carbon fiber that is a retrieved product from a composite material. The reason for this is not clear, but is presumed to be that a carbon fiber non-woven cloth that includes a carbon fiber, from which an organic substance has been removed by a process of retrieval from a composite material, has a favorable compatibility with a resin, thereby achieving a tight fixation.

The method of determining whether or not a carbon fiber is a “retrieved product from a composite material including the carbon fiber and an organic substance” is not particularly limited. For example, a carbon fiber that does not fully or partially form a strand may be determined as a “retrieved product from a composite material including the carbon fiber and an organic substance”. This is because a carbon fiber becomes an independent filament through a process of retrieval from a composite material, i.e., an organic substance such as a sizing agent is removed from the carbon fiber to cause separation of at least a portion of the carbon fiber from a strand.

The method of obtaining a carbon fiber that is a retrieved product from a composite material including the carbon fiber and an organic substance is not particularly limited, and examples thereof include a method of subjecting a carbon fiber or a composite material to a thermal treatment at a temperature at which an organic substance is eliminated (see, for example, JP-A No. 2013-237716) and a method of contacting a processing solution capable of decomposing an organic substance with a carbon fiber or a composite material (see, for example, JP-A No. 2001-172426).

From the viewpoint of reducing the damage to the carbon fiber and reducing the amount of the residual organic substance, a method of using a processing solution including an organic solvent and a decomposition catalyst is preferred. In terms of cost, a method of removing an organic substance such as a resin from a waste material generated in the production of a prepreg, CFRP and the like is preferred.

The proportion of the “carbon fiber that is a retrieved product from a composite material including the carbon fiber and an organic substance” in the carbon fiber non-woven cloth is not particularly limited, and may be selected depending on the purpose or the like of the carbon fiber non-woven cloth. For example, the proportion of the “carbon fiber that is a retrieved product from a composite material including the carbon fiber and an organic substance” may be 10% by mass or more of the total mass of the carbon fiber in the carbon fiber non-woven cloth, preferably 30% by mass or more, more preferably 50% by mass or more.

In this aspect, the length of the carbon fiber, the diameter of the carbon fiber, and the thickness of the carbon fiber non-woven cloth are not particularly limited, and preferred ranges thereof are the same as the first aspect.

The carbon fiber non-woven cloth may include a carbon fiber alone, or may include a carbon fiber and a resin fiber. A carbon fiber non-woven cloth that includes a resin fiber tends to make the production thereof easier and improve the handleability. This is because a resin fiber entangles with a carbon fiber and achieves a stable retention of the shape of a carbon fiber non-woven cloth. The carbon fiber non-woven cloth may include a single kind of the resin fiber, or two or more kinds of the resin fiber.

When the carbon fiber non-woven cloth includes a resin fiber, the type of the resin fiber is not particularly limited and examples thereof include a synthetic fiber of a thermoplastic resin, a thermoplastic resin and the like, and a regenerated fiber of rayon and the like.

In particular, when the carbon fiber non-woven cloth includes a fiber of a thermoplastic resin, a composite material can be produced by performing a hot pressing to melt the resin fiber, without performing a process of impregnating the carbon fiber non-woven cloth with a resin. In addition, favorable handleability and mold following capability are achieved in a case of producing the carbon fiber non-woven cloth by a resin transfer molding method.

The thermoplastic resin that forms a resin fiber is not particularly limited, and examples include polypropylene, polyethylene terephthalate, nylon 6, nylon 66, polycarbonate, and polystyrene.

When the carbon fiber non-woven cloth includes a resin fiber, the content of the carbon fiber is preferably from 20% by mass to less than 99% by mass (the content of the resin fiber is preferably from 1% by mass to less than 80% by mass) of the total of the carbon fiber and the resin fiber. In that case, a composite material produced by using the carbon fiber non-woven cloth tends to have a high elastic modulus.

The content of the carbon fiber is more preferably from 30% by mass to less than 90% by mass (the content of the resin fiber is preferably from 10% by mass to less than 70% by mass), further preferably from 35% by mass to less than 85% by mass (the content of the resin fiber is preferably from 20% by mass to less than 65% by mass).

<Method of Producing Carbon Fiber Non-Woven Cloth>

The method of producing a carbon fiber non-woven cloth includes, in the following order:

a contact process of contacting a processing solution with a composite material, the composite material including a carbon fiber and an organic substance that decomposes in the processing solution;

a separation process of separating the processing solution, which includes a decomposition product of the organic substance, from the carbon fiber; and

a non-woven cloth producing process of producing a carbon fiber non-woven cloth using the carbon fiber that is obtained through the contact process and the separation process.

In the specification, the “decomposition” of an organic substance refers to changing the molecular structure of the organic substance to a size that is small enough to be incorporated into a processing solution.

The composite material to which the method is applicable is not specifically limited as long as it includes an organic substance that decomposes with a processing solution used in the method, and a carbon fiber.

Examples of the organic substance include a resin. When the organic substance is a resin, it may be a thermosetting resin or a thermoplastic resin. The resin may be in a state of fully cured or solidified, or may not be in a state of fully cured or solidified.

When the organic substance is a resin, its type is not specifically limited and may be selected depending on the conditions such as the type of the processing solution, the processing temperature and the processing time. From the viewpoint of decomposability with the processing solution, a resin having an ester bond is preferred. Examples of the resin having an ester bond include a polyester resin (such as an unsaturated polyester resin and a saturated polyester resin) and an epoxy resin having an ester bond (such as an epoxy resin cured with an acid anhydride and a glycidyl ester-type epoxy resin). The composite material may include a single kind of the organic substance or two or more kinds of the organic substance.

The processing solution used in the method is not particularly limited, as long as it is capable of decomposing the organic substance in the composite material. For example, when the organic substance includes a resin including an ester bond, it is preferred to use a processing solution that causes decomposition of an ester bond. Examples of the processing solution that causes decomposition of an ester bond include a processing solution including an organic solvent and a decomposition catalyst.

When the processing solution includes an organic solvent, the type of the organic solvent is not particularly limited, and examples thereof include an alcohol solvent, a ketone solvent, an ether solvent, an amide solvent, and an ester solvent.

Examples of the amide solvent include formamide, N-methyl formamide, N,N-dimethyl formamide, N,N-diethyl formamide, acetamide, N-methyl acetamide, N,N-dimethyl acetamide, N,N,N′,N′-tetramethyl urea, 2-pyrolidone, N-methyl-2-pyrolidone, caprolactam, and a carbamic acid ester.

Examples of the alcohol solvent include methanol, methanol, ethanol, 1-propanol, 2-propanol, 1-butanol, 2-butanol, isobutanol, tert-butanol, 1-pentanol, 2-pentanol, 3-pentanol, 2-methyl-1-butanol, isopentyl alcohol, tert-pentyl alcohol, 3-methyl-2-butanol, neopentyl alcohol, 1-hexanol, 2-methyl-1-pentanol, 4-methyl-2-pentanol, 2-ethyl-1-butanol, 1-heptanol, 2-heptanol, 3-heptanol, cyclohexanol, 1-methyl cyclohexanol, 2-methyl cyclohexanol, 3-methyl cyclohexanol, 4-methyl cyclohexanol, ethylene glycol, ethylene glycol monomethyl ether, ethylene glycol monoethyl ether, ethylene glycol monopropyl ether, ethylene glycol monobutyl ether, diethylene glycol, diethylene glycol monomethyl ether, diethylene glycol monoethyl ether, diethylene glycol monopropyl ether, diethylene glycol monobutyl ether, triethylene glycol, triethylene glycol monomethyl ether, triethylene glycol monoethyl ether, tetraethylene glycol, polyethylene glycol (Mw: from 200 to 400), 1,2-propane diol, 1,3-propane diol, 1,2-propane diol, 1,3-butane diol, 1,4-butane diol, 2,3-butane diol, 1,5-pentane diol, glycerin, dipropylene glycol, and benzyl alcohol.

Examples of the ketone solvent include acetone, methyl ethyl ketone, 2-pentanone, 3-pentanone, 2-hexanone, methyl isobutyl ketone, 2-heptanone, 4-heptanone, diisobutyl ketone, cyclohexanone, methyl cyclohexanone, phorone, isophorone acetyl acetone, and acetophenone.

Examples of the ether solvent include dipropyl ether, diisopropyl ether, dibutyl ether, dihexyl ether, anisole, phenetol, dioxane, tetrahydrofuran, acetal, ethylene glycol dimethyl ether, ethylene glycol diethyl ether, diethylene glycol dimethyl ether, diethylene glycol monomethyl ether, diethylene glycol monobutyl ether, and diethylene glycol diethyl ether.

Examples of the ester solvent include methyl formate, ethyl formate, propyl formate, butyl formate, isobutyl formate, pentyl formate, methyl acetate, ethyl acetate, propyl acetate, isopropyl acetate, butyl acetate, isobutyl acetate, pentyl acetate, isopentyl acetate, 3-methoxybutyl acetate, 2-ethylbutyl acetate, 2-ethylhexyl acetate, cyclohexyl acetate, benzyl acetate, methyl propionate, ethyl propionate, butyl propionate, isopentyl propionate, methyl lactate, ethyl lactate, butyl lactate, methyl butyrate, ethyl butyrate, butyl butyrate, isopentyl butyrate, isobutyl isobutyrate, ethyl isovalerate, isopentyl isovalerate, methyl benzoate, ethyl benzoate, propyl benzoate, butyl benzoate, γ-butyrolactone, diethyl oxalate, dibutyl oxalate, diethyl malonate, methyl salicylate, ethylene glycol diacetate, tributyl borate, trimethyl phosphate, and triethyl phosphate.

In view of the ability to decompose a resin having an ester bond, such as an epoxy resin cured with an acid anhydride, via an ester exchange reaction, the solvent is preferably an alcohol solvent, more preferably a monoalcohol that has one hydroxy group in view of suppressing a side reaction of a decomposition product. From the viewpoint of the ability to decompose, benzyl alcohol is further preferred. The processing solution may include a single kind of the organic solvent or two or more kinds of the organic solvent.

When the processing solution includes a decomposition catalyst, examples of the decomposition catalyst include an alkali metal compound, such as a phosphoric salt, and a metallic hydroxide. Examples of the phosphoric salt include tripotassium phosphate, trirubidium phosphate, trisodium phosphate, and trilithium phosphate. Examples of the metallic hydroxide include rubidium hydroxide, potassium hydroxide, sodium hydroxide and lithium hydroxide.

From the viewpoint of decomposing an organic substance with high efficiency, the decomposition catalyst is preferably potassium hydroxide or sodium hydroxide. The processing solution may include a single kind or two or more kinds of the decomposition catalyst. When the processing solution includes a decomposition catalyst, the concentration of the decomposition catalyst is not particularly limited, and may be from 0.3 mol/L to 1 mol/L, for example.

The direction of the carbon fiber in the composite material is not particularly limited. For example, the carbon fiber may be positioned in an orthogonal manner, in a unidirectional manner, or in a random manner. The composite material may include a single kind of carbon fibers, or two or more kinds that are different in shape or the like.

The composite material may be cut into a desired size. For example, if the carbon fibers are positioned in an orthogonal manner, carbon fibers having the same length can be retrieved by cutting the composite material into square pieces along with the directions of the carbon fibers. The length of the carbon fiber is not particularly limited, and may be selected depending on the desired properties of the carbon fiber non-woven cloth to be produced.

The method of contacting the processing solution with the composite material is not particularly limited, and examples thereof include a method of immersing the composite material in the processing solution, and a method of spraying or coating the composite material with the processing solution. From the viewpoint of decomposing the organic substance and incorporating the decomposition product into the processing solution with high efficiency, a method of immersing the composite material in the processing solution is preferred.

From the viewpoint of promoting the decomposition of the organic substance in the composite material, the processing solution is preferably flowing while contacting the composite material. The method for allowing the processing solution to flow may be, for example, a method of immersing the composite material with the processing solution in a container equipped with a tube to allow the processing solution to flow in and a tube to allow the processing solution to flow out. The direction for the processing solution to flow is not particularly limited, and may be in a horizontal direction or in a gravitational direction, for example.

In the contact process, the temperature of the processing solution is not particularly limited as long as an organic substance can decompose. For example, the temperature of the processing solution may be from 50° C. to 300° C., preferably from 100° C. to 200° C. The temperature of the processing solution may remain constant or may change, during the contact process.

The method for separating the processing solution including a decomposition product of the organic substance from the carbon fiber is not particularly limited. For example, when the contact process is conducted in a container, the processing solution may be taken from the container prior to the carbon fiber, or the carbon fiber may be taken from the container prior to the processing solution.

The processing solution including a decomposition product of the organic substance after the separation process may be discarded or reused. In a case of reusing the processing solution, the processing solution may be subjected to a treatment such as removal of a decomposition product of the organic substance or other components (e.g. a substance generated by the decomposition reaction), addition of a fresh processing solution, and the like.

The carbon fiber after the separation process may be attached with an organic substance that was not decomposed by the processing solution. In that case, the organic substance may be removed by further conducting a contact process and a separation process, as necessary. When further conducting a contact process and a separation process, the method thereof is not particularly limited and may be conducted under the same conditions as described above or under the different conditions. Alternatively, the organic substance may be removed by performing a thermal treatment at a temperature at which the organic substance is eliminated.

The composite material may further include an organic substance that does not decompose with the processing solution. In that case, a process for removing the organic substance may be performed. Examples of the method includes adjusting the temperature of the processing solution to be contacted with the carbon fiber to a temperature that is equal to or greater than a softening point of the organic substance that does not decompose with the processing solution, thereby softening the organic substance and separating the same from the carbon fiber. From the viewpoint of separating the organic substance while being incorporated into the processing solution, it is preferred to maintain the temperature of the processing solution to be at least a softening point of the organic substance until the completion of the separation of the processing solution from the carbon fiber.

When the decomposition of the organic substance with the processing solution is performed through the decomposition of an ester bond, examples of the organic substance that does not decompose with the processing solution include a resin that does not have an ester bond. Examples of the resin that does not have an ester bond include a polyolefin resin such as polypropylene and polyethylene, a polyamide resin, and a polypropylene resin.

The process for preparing a non-woven cloth by using the carbon fiber is not particularly limited, and may be performed by a known method. As necessary, a material other than the carbon fiber, such as a resin fiber, may be used in combination. Examples of the process for preparing the carbon fiber non-woven cloth include opening the carbon fiber by a carding machine. In a case of blending a resin fiber or the like, a non-woven cloth including a carbon fiber and a resin fiber can be obtained by placing the carbon fiber and the resin fiber in a carding machine and performing blending and opening of the same. In a case of using a resin fiber, the carbon fiber and the resin fiber are preferably mixed as uniformly as possible.

<Carbon Fiber Multi-Layer Cloth>

The carbon fiber multi-layer cloth includes the carbon fiber non-woven cloth as described above and a carbon fiber sheet in which the carbon fiber is oriented in at least one direction.

The number of the carbon fiber non-woven cloth and the carbon fiber sheet in the carbon fiber multi-layer cloth is not particularly limited, and each of them may be one or two or more, independently. The carbon fiber multi-layer cloth may include a component other than the carbon fiber non-woven cloth and the carbon fiber sheet, as necessary.

In the specification, the “carbon fiber sheet in which the carbon fiber is oriented in at least one direction” refers to a carbon fiber sheet with the proportion of the carbon fiber is 30% by mass or more, and the carbon fiber in the form of a strand or a filament is oriented in at least one direction. Examples of the carbon fiber sheet include a carbon fiber material in which the carbon fiber is positioned in an orthogonal manner (cloth material) and a carbon fiber material in which the carbon fiber is positioned in one direction (UD material). By using a carbon fiber material that is oriented in at least one direction, which exhibits an excellent strength, a sufficient strength can be imparted to the carbon fiber multi-layer cloth even when the carbon fiber non-woven cloth is not strong enough alone.

The structure of the carbon fiber multi-layer cloth is not particularly limited. For example, the carbon fiber multi-layer cloth may have a carbon fiber sheet on one side of a carbon fiber non-woven cloth, or may have a carbon fiber sheet on both sides of a carbon fiber non-woven cloth. The carbon fiber multi-layer cloth may have a layer other than a carbon fiber sheet or a carbon fiber non-woven cloth, as necessary.

The thickness of the carbon fiber multi-layer cloth is not particularly limited. For example, in view of handleability during preparation of the composite material, the thickness of the carbon fiber multi-layer cloth is preferably 100 mm or less.

<Composite Material>

The composite material includes the carbon fiber non-woven cloth or the carbon fiber multi-layer cloth as described above, and a resin. The composite material may include a component or a member other than the carbon fiber non-woven cloth, the carbon fiber multi-layer cloth or the resin, as necessary.

The type of the resin in the composite material is not particularly limited, and may be selected depending on the purpose of the composite material, and the like. Examples of the resin include a thermoplastic resin such as a polyamide resin and a polypropylene resin, and a thermosetting resin such as an epoxy resin.

The state of the resin in the composite material is not particularly limited, and may be fully or partially cured or solidified, or may not be fully or partially cured or solidified.

The method for producing the composite material is not particularly limited, and may be performed by a known method such as a RTM method, an autoclave method, or a pressing method. Since the composite material exhibits an excellent formability, it is suitably used for the production of an object with a complicate shape by a RTM method.

The purpose of the composite material is not particularly limited, and examples thereof include a body or an interior/exterior material of a car, an airplane and the like, a thermal insulating material, and an electronic wave-shielding film.

### EXAMPLES

In the following, the embodiments are described in further detail by referring to the Examples. However, the embodiments are not limited to the Examples.

### Example 1

A carbon fiber was separated from a composite material under the following conditions.

As the composite material, a prepreg material including an epoxy resin having an ester bond and a carbon fiber cloth material (thickness: 0.4 mm, resin content: 45% by mass) was used. As the processing solution, a mixture of benzyl alcohol and sodium hydroxide (content of sodium hydroxide: 0.5 mol/L) was used.

(Contact Process)

The composite material was cut into square pieces (4 cm×4 cm) along the direction of the carbon fiber, and contacted with the processing solution in a container. The container had a tube for the processing solution to flow in and a tube for the processing solution to flow out, and the latter is positioned below the former in a gravitational direction such that the processing solution flows from the bottom to the top in a gravitational direction. The temperature of the processing solution was set at 60° C. for 2 hours at the beginning of the immersion, and subsequently at 190° C. for 5 hours.

(Separation Process)

At 7 hours after the beginning of the immersion, the processing solution was drained from the container to separate from the carbon fibers. The temperature of the processing solution at the separation process was set at 60° C. The processing solution after the separation process included a decomposition product of the epoxy resin.

The observation found that the carbon fibers after the separation included carbon fibers in a state of an independent filament without forming a strand. The content of the organic substance with respect to the total mass of the carbon fibers and the organic substance, calculated by the method as described above using a muffle furnace (Yamato Scientific Co., Ltd., FP311), was 1.3% by mass, indicating that the carbon fiber does not substantially has an organic substance.

(Preparation of Carbon Fiber Non-Woven Cloth)

A carbon fiber non-woven cloth was obtained by opening 5.7 kg of the carbon fiber and 4.3 kg of polypropylene fibers as a resin fiber (JNC Corporation, RP-270, fineness: 6.6 Dt, average filament length: 51 mm) with a carding machine. The basis weight of the carbon fiber non-woven cloth was 200 g/m². The carbon fiber non-woven cloth had a sufficient flexibility that is applicable for the formation of a three-dimensional object.

(Preparation of Composite Material)

A laminate having a basis weight of 2500 g/m² was prepared by stacking plural layers of the carbon fiber non-woven cloth. The laminate was subjected to hot pressing by sandwiching with a small hot pressing machine (AS ONE Corporation) with a spacer of 2.7 mm and pressing at 43 kg/cm² at 200° C., thereby preparing a composite material.

(Evaluation of Strength)

The composite material was cut with a rotating cutter (Makita Corporation) attached with a rotating blade (Tanitec Corporation) to obtain 10 test pieces of 2.5 cm in width and 8 cm in length. The bending strength and the bending elastic modulus of the test pieces were measured by a three-point bending method according to JIS K 7171. The measurement was performed with a universal tester (Shimadzu Corporation, AUTOGRAPH AG-X 1kN). The average of the measured values obtained from the test pieces was 232 MPa (bending strength) and 13 GPa (bending elastic modulus).

### Comparative Example 1

A carbon fiber non-woven cloth and a composite material were prepared in the same manner as Example 1, except that the same amount of carbon fibers with an organic substance (sizing agent) attached to the surface was used as the carbon fibers, and the measurement was performed. The average of the measured values obtained from the test pieces was 190 MPa (bending strength) and 9 GPa (bending elastic modulus).

The results show that a composite material with excellent formability and strength can be prepared by the embodiment.

1. A carbon fiber non-woven cloth that satisfies at least one of the following (1) to (3):
(1) includes a carbon fiber that does not substantially include an organic material,
(2) includes a carbon fiber that does not form a strand, or
(3) includes a carbon fiber that is a retrieved product from a composite material including the carbon fiber and an organic substance.

2. The carbon fiber non-woven cloth according to claim 1, wherein a length of the carbon fiber is from 20 mm to 150 mm.

3. The carbon fiber non-woven cloth according to claim 1, further comprising a resin fiber.

4. A method of producing the carbon fiber non-woven cloth according to claim 1, the method comprising, in the following order:
a contact process of contacting a processing solution with a composite material, the composite material including a carbon fiber and an organic substance that decomposes in the processing solution;
a separation process of separating the processing solution, which includes a decomposition product of the organic substance, from the carbon fiber; and
a non-woven cloth producing process of producing a carbon fiber non-woven cloth using the carbon fiber that is obtained through the contact process and the separation process.

5. The method of producing a carbon fiber non-woven cloth according to claim 4, wherein the organic substance comprises a resin including an ester bond.

6. The method of producing a carbon fiber non-woven cloth according to claim 4, wherein the processing solution comprises an organic solvent and a decomposition catalyst.

7. A carbon fiber multi-layer cloth, comprising the carbon fiber non-woven cloth according to claim 1 and a sheet in which carbon fibers are oriented in at least one direction.

8. A composite material, comprising the carbon fiber non-woven cloth according to claim 1, and a resin.

9. A composite material, comprising the carbon fiber multi-layer cloth according to claim 7, and a resin.
